(19) United States
(12) Patent Application Publication
(10) Pub. No.: US 2013/0008140 A1
(43) Pub. Date: Jan. 10, 2013

(54) SEPARATOR FOR REMOVING LIQUID FROM AIRFLOW

(76) Inventors: Anthony Richard PIKE, Alton (GB); Ronald Charles Cosgrove, Alton (GB); Stephen David Hiner, Alton (GB)

(21) Appl. No.: 13/543,502

(22) Filed: Jul. 6, 2012

(30) Foreign Application Priority Data
Jul. 8, 2011 (GB) 1111745.4

(51) Int. Cl. B01D 45/08

(52) U.S. Cl. 55/464

(57) ABSTRACT

A separator comprises a plurality of vanes which protrude upwardly from a lower surface of an air intake duct to separate a flow of water from air. The separator also includes a hydro-cyclone that increases the separation of the water and air using a vortex effect.

### BACKGROUND OF THE INVENTION

Embodiments of the present invention relates to separators for separating water from airflow. In particular, embodiments of the present invention are applicable to gas turbine air intake systems, but could be used in other situations requiring the separation of a liquid from a gas.

For the optimum operation of gas turbines, as much water as possible should be removed from the intake air. Existing air intake systems usually incorporate two stages of water separation and a particle filtration stage. Various types of filters can be used, e.g. depth filtration media, and vanes can be arranged in the intake to trap passing water and remove it from the system. Spray hoods can be used to prevent entry of falling droplets into the system.

Other known water removal means include coalescers, hydrophobic filters and centrifuges for example. Each of these prior art devices introduces significant interruption to the air stream and results in a high pressure drop of the intake air.

Such traditional means are good at removing small droplets of water, e.g. moisture drops entrained in the intake air, but can be overwhelmed by bulk quantities of liquid entering the system. References herein to “bulk liquid” are intended to cover quantities of liquid that flow to a large extent independently of the airflow entering the intake duct and under the influence of gravity tend to flow along the bottom of the duct, rather than drops of liquid entrained in a flow of air. In practice, both types of liquid flow may be present in the air intake. For example, gas turbine air intakes on ships may be deluged by large waves, which could enter the intake system and overwhelm the traditional water removal means. The presence of salt in the water adds to the potential damage it can cause if it reaches the gas turbine.

### BRIEF DESCRIPTION OF THE INVENTION

One aspect of the present invention provides a separator for mounting on a lower or lateral surface of a gas turbine air intake duct and for removing bulk liquid that enters the duct, the separator comprising one or more flow directing members which protrude in an upward direction to intercept a flow of liquid and direct the liquid away from the gas turbine.

Another aspect of the present invention provides an air intake system for a gas turbine comprising a duct through which air flows to a gas turbine, and a separator disposed at a lower or lateral surface of the duct to separate liquid from the airflow, the separator extending along the direction of flow, whereby at least some of the liquid that enters the duct flows over and into the separator, the separator comprising one or more flow directing members which protrude upwardly above the lower duct surface to intercept the liquid and direct the liquid away from the gas turbine.

A further aspect of the present invention provides an air intake system for a gas turbine for removing water from a flow of air, the system comprising a duct in which a first water/air separator is positioned in an upstream location, and a second water/air separator is positioned downstream of the first separator, the second separator being provided on a lower or lateral side of the duct to remove bulk quantities of water which have passed through the first separator.

### BRIEF DESCRIPTION OF THE DRAWINGS

There follows a detailed description of embodiments of the invention by way of example only and with reference to the accompanying schematic drawings, in which:

FIG. 1 is a cross-sectional view of a separator according to a first embodiment of the invention;

FIG. 2 is a top plan view of a separator according to the embodiment shown in FIG. 1;

FIG. 3 is a perspective view embodiment shown in FIG. 1;

FIG. 4 is a cross-sectional view of an air intake system for a gas turbine;

FIG. 5 is a cross-sectional view of a flow directing member;

FIG. 6 is a cross-sectional view of a separator according to a second embodiment of the invention; and

FIG. 7 is a perspective view of the embodiment shown in FIG. 6.

### DETAILED DESCRIPTION OF THE INVENTION

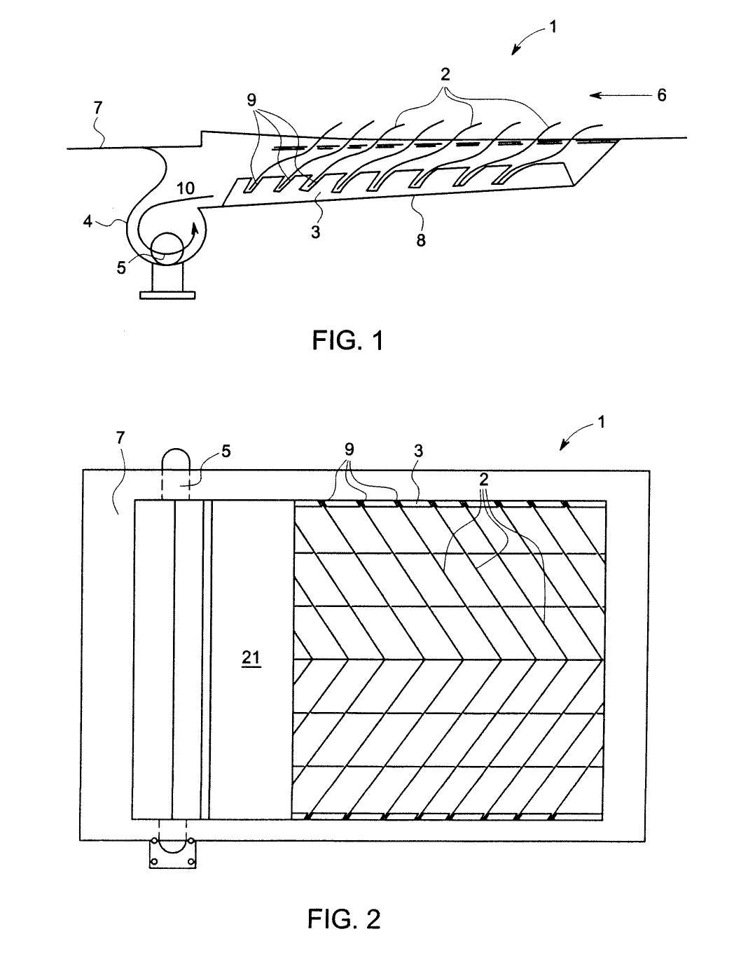

FIG. 1 shows in cross section a water separator 1 according to a first embodiment of the invention. The separator 1 is located on a bottom surface of an air intake duct. A flow of air and water 6 impinges on the separator in the direction shown by an arrow 6, i.e. from the right in FIG. 1. The separator 1 comprises a series of flow directing members 2 which protrude upwardly into the flow 6 intercepting at least a portion thereof and directing the flow to a bottom surface 8 of the separator 1, which surface is also referred to herein as a tray 8. Water caught in the tray is drained away via a drain hole, as discussed in more detail below.

The flow directing members 2 comprise vanes 2. The vanes 2 are mounted in lateral mounts 3 which comprise a series of slots 9 each of which supports a bottom portion of a vane 2. The slots 9 are angled so that the vanes 2 protrude upwardly and towards the flow direction to capture as much as possible of any water flowing therover. The vanes can be attached to the mounts using any suitable means, such as tack-welding.

The separator 1 has two main sections designed to separate the water from the air, the first section comprising the series of vanes 2. The second section comprises a portion 4 of rounded cross section, also referred to as a hydro-cyclone. In use, a captured flow of water and air travels along the tray 8 in a leftward direction as shown in FIG. 1 and enters the hydro-cyclone 4. Here, the flow follows the contour of the hydro-cyclone, assuming a circular path, as shown by an arrow 10. The water and air streams induce a vortex in the hydro-cyclone and centrifugal effects urge the water to the outer perimeter of the hydro-cyclone 4. The water then drains out of the separator 1 through an exit hole 5, whilst the air can escape upwardly back into the air intake duct and still contribute to the intake of the gas turbine. Optionally, a vacuum pump (not shown) may be connected to the hydro-cyclone to promote the cyclone effect. The first and second sections work in conjunction with one another to improve the removal of water from the flow.

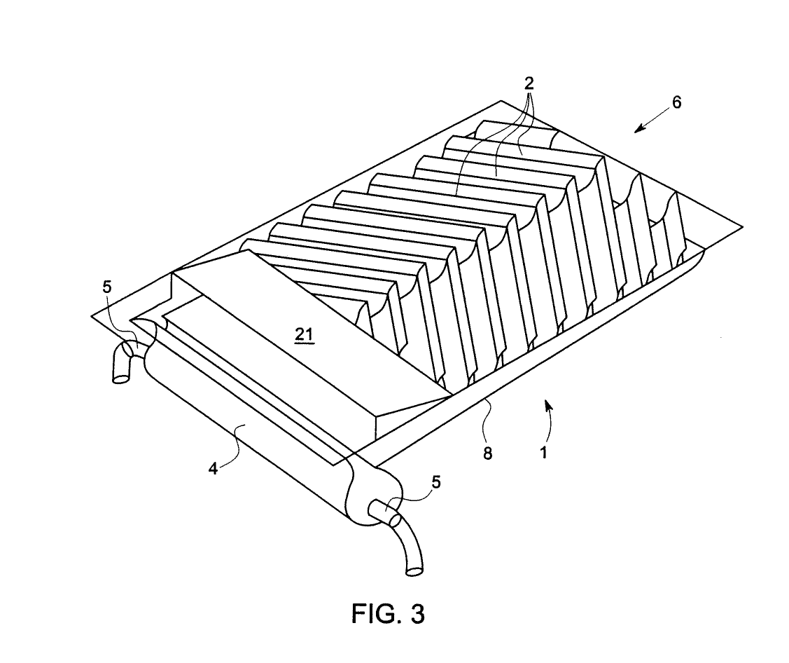

FIG. 2 shows the separator 1 from above. The separator 1 covers the whole width of a section of the intake duct, to maximize water capture. FIG. 3 shows the separator in perspective. An air exit chute 21 is provided near the downstream end of the separator 1.

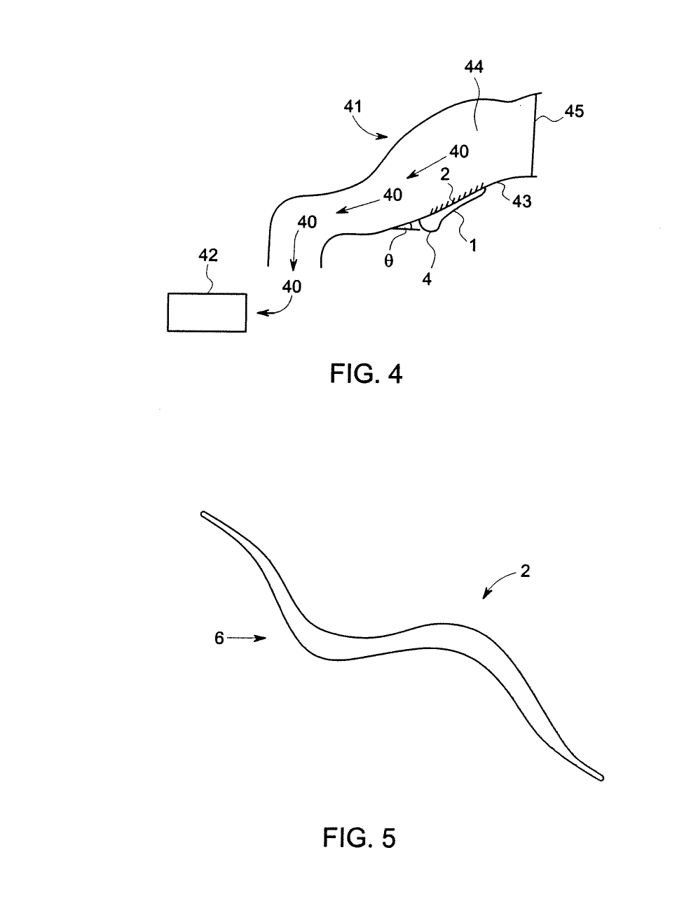

FIG. 4 is a schematic cross-sectional view of an air intake system 41 for a gas turbine 42 including a duct 44. Arrows 40 show the direction of flow through the system 41. A conventional filter screen 45 is disposed at the mouth of the duct. The separator 1 is disposed on a lower surface 43 of the duct 44, which is at an angle θ to the horizontal. Preferably θ is approximately equal to 35 degrees, but in the extremes, the lower surface can be horizontal or alternatively approaching 90 degrees to the horizontal. Preferably θ lies in the range of 20° to 50°. The separator 1 slopes downwardly in the direction of flow in the preferred embodiment. The separator 1 is positioned downstream of the conventional filter screen and thus the separator 1 lies directly in the path of any bulk flow of water that comes through the initial filter screen 45. As well as capturing such bulk flows, the separator 1 captures water droplets entrained in the air flow entering the separator 1. The lower surface of the duct walls meets flush with the side of the separator. Further traditional filters can be provided in the duct upstream or downstream of the separator. Additionally the separator can be adapted to cover lateral portions of the duct as well as the lower surface or additional separators can be eclipsed at the sides of the duct. In an alternative embodiment, not shown in the drawings, the separator 1 can be provided upstream of the conventional filter screen 45 and would then also protect the convention filter screen from damage by bulk water ingress.

FIG. 5 shows in cross-section a vane 2 which forms part of the separator 1. The flow of air and water 6 impinges on the vane 2 from the left as shown in FIG. 5. The vane 2 has a serpentine form that encourages separation of the water and air.

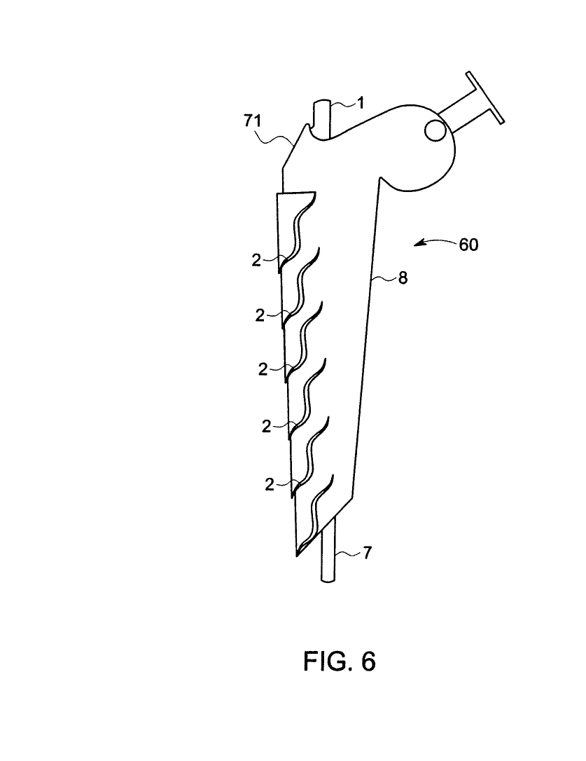

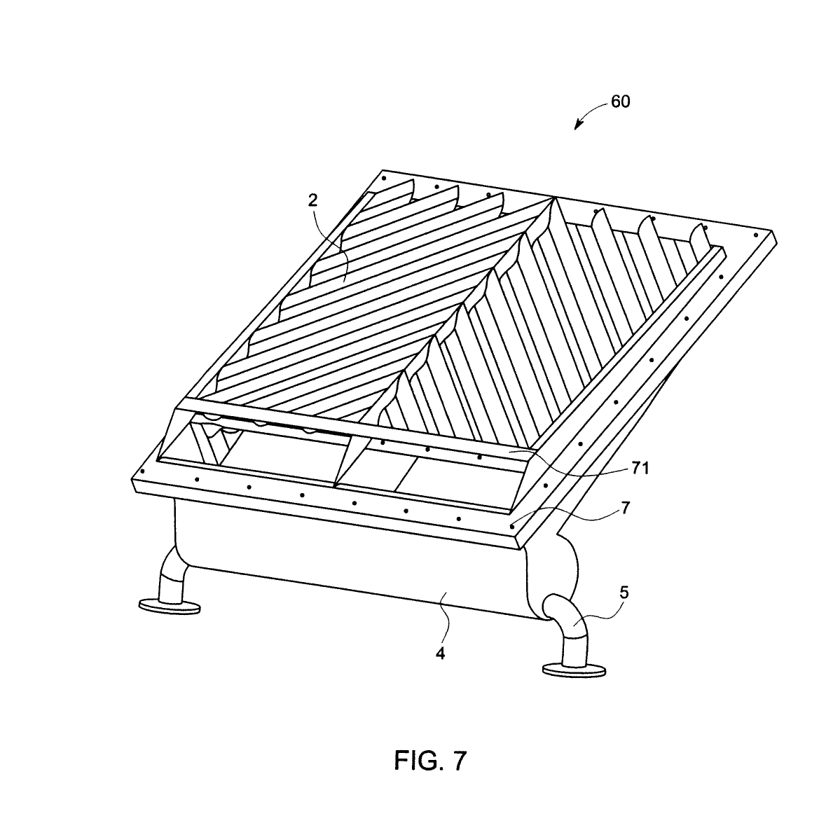

FIG. 6 shows a cross-section through the middle of a second embodiment of the separator 60, which is largely the same as the first embodiment. The separator 60 has a slightly different air exit chute 71 which is smaller than that of the first embodiment, thus maximizing the area of the vanes 2. In the preferred embodiment as shown in FIG. 6, a series of 6 vanes is provided, although any suitable number can be provided. Computational fluid dynamic analysis shows that 7% of airflow passes through the separator 1 but its location at the low side of the intake duct captures a relatively large amount of bulk water that may enter the intake duct. The separator is capable of removing at least 20 litres of bulk water per second per metre width of the duct.

The separator 1 according to an embodiment of the invention provides many advantages over prior art intake systems that do not have such a separator. The separator provides an additional “last chance” device to prevent water from entering the turbines, so that even in the event of the initial filters being overwhelmed, catastrophic entry of bulk water to the gas turbine can be prevented. The separator thus protects against ingestion of water into the air intake and prevents water damage to the engines and other downstream devices. Continuous system operation is thereby facilitated and increased reliability of the gas turbine is provided.

The separator can by designed to suit any intake duct and can be retro-fitted to existing air intakes. The separator incurs a minimal pressure loss of the airflow. As noted above 7% of incoming air goes through the device. Further, the device has no moving parts and no maintenance and incurs zero running costs.

When installed in a ship, embodiments of the invention provides the additional advantages of maintaining the ship and its systems in service, and avoids high gas turbine repair and replacement costs.

In a preferred embodiment, the separator is made entirely from Aluminium, for its good strength and corrosion resistance and relatively light weight. Alternative materials include stainless steel or plastics for example.

In a further embodiment it is proposed to include a substantial sump below the separator to collect the water ingress. In a ship, this may require a substantial redesign of surrounding areas of the ship's structure.

What is claimed is:

1. A separator for mounting on a lower or lateral surface of a gas turbine air intake duct and for removing liquid that enters the duct, the separator comprising one or more flow directing members which protrude in an upward direction to intercept a flow of liquid and direct the liquid away from the gas turbine.

2. The separator according to claim 1, wherein a downstream region of the separator has a generally circular cross-section, whereby the flow of air and liquid follows a generally circular path in the downstream region.

3. The separator according to claim 1, wherein the separator is disposed at an angle of approximately 35 degrees to the horizontal.

4. The separator according to claim 1, wherein the flow directing members comprise vanes.

5. The separator according to claim 4, wherein the vanes are mounted in a frame comprising first and second side walls.

6. The separator according to claim 4, wherein the vanes extend upwardly beyond the side walls.

7. The separator according to claim 4, wherein a tray is provided under the vanes to guide liquid towards the downstream region of the separator.

8. The separator according to claim 4, wherein the vanes are oriented obliquely relative to the direction of flow.

9. The separator according to claim 4, wherein the vanes are arranged in a chevron formation.

10. The separator according to claim 4, wherein the vanes are mounted in lateral mounts which angle the vanes towards the flow direction, whereby the flow of liquid is guided downwardly and out of the duct.

11. An air intake system for a gas turbine comprising a duct through which air flows to a gas turbine, and a separator disposed at a lower or lateral surface of the duct to separate liquid from the airflow, the separator extending along the direction of flow, whereby at least some of the liquid that enters the duct flows over and into the separator, the separator comprising one or more flow directing members which protrude upwardly above the lower duct surface to intercept the liquid and direct the liquid away from the gas turbine.

12. The air intake system according to claim 11, wherein a downstream region of the separator has a generally circular cross-section, whereby the flow of air and liquid follows a generally circular path in the downstream region.

13. The air intake system for a gas turbine for removing water from a flow of air, the system comprising a duct in which a first water/air separator is positioned in an upstream location, and a second water/air separator is positioned downstream of the first separator, the second separator being provided on a lower or lateral side of the duct to remove bulk quantities of water which have passed through the first separator.

14. The air intake system according to claim 13, wherein the second separator is capable of removing at least 20 litres of water per second per metre width of the duct.
